(19) United States
(12) Patent Application Publication
(10) Pub. No.: US 2024/0118975 A1
(43) Pub. Date: Apr. 11, 2024

(54) IINFORMATION PROCESSING SYSTEM, MANAGEMENT APPARATUS, MANAGEMENT METHOD, AND PROGRAM

(71) Applicant: Nippon Telegraph and Telephone Corporation, Tokyo (JP)

(72) Inventors: Takato TODA, Musashino-shi, Tokyo (JP); Nobuhiro KIMURA, Musashino-shi, Tokyo (JP); Kotaro MIHARA, Musashino-shi, Tokyo (JP)

(21) Appl. No.: 18/277,012

(22) PCT Filed: Feb. 15, 2021
(86) PCT No.: PCT/JP2021/005458

§ 371 Date: Aug. 11, 2023

(51) Int. Cl. G06F 11/14; G06F 9/455

(52) U.S. Cl. CPC G06F 11/1446; G06F 9/45533

(57) ABSTRACT

A call control system includes a management device (30) which manages one or more virtual machines (10) operating on a virtualization platform. The virtual machine (10) includes a volume (12) in which an OS, an MW, and an APL which are not updated in operation are installed, a volume (13) in which data which is updated in operation is arranged, and a recovery unit (11) which transmits an image acquisition request for the volume (13) to the management device (30). The management device (30) includes a management unit (31) which creates the virtual machine (10) by arranging an image file including an OS, an MW, and an APL to the volume (12) and arranging an image file including data which is updated while the virtual machine (10) is operating to the volume (13) and a backup unit (32) which backs up the volume (13) as an image file in response to an image acquisition request from the virtual machine (10). The recovery unit (11) expands an initialization range step by step when a software failure occurs, restarts the software, and transmits a volume creation request to the management device (30) when the initialization range reaches a predetermined stage. The backup unit (32) creates a new volume (13) using the image file in response to the volume creation request. The recovery unit (11) replaces the volume (13) with a new volume (13) created in response to the volume creation request.

### TECHNICAL FIELD

The present invention relates to an information processing system, a management device, a management method, and a program.

### BACKGROUND ART

Call control servers are servers which provide call services using telephones. Due to the nature of the service, the call control servers require high availability. Although current call control servers are built with dedicated hardware, migration of the call control server to a virtual environment is being considered in response to the recent high performance of commercial hardware and the popularity of system virtualization.

### CITATION LIST

### Non Patent Literature

[NPL 1] Kawaguchi, three others, “Evaluation on Application of Virtualization Technology to SIP Servers”, IEICE Technical Report, vol. 117, No. 131, NS2017-70, pp. 211-216, July 2017
[NPL 2] Zhu and two others, “Study on Partial Backup and Restoration Method in Virtual Environment”, IEICE General Conference Correspondence Lecture Proceedings 2 B-6-19, March

### SUMMARY OF INVENTION

### Technical Problem

Current call control servers periodically back up data to file servers. The backup file mainly includes information relating to subscriber data editing, data defining the operation of the call control server alone and the like. A backup file is taken once a day. When recovering from a hardware failure, alternative hardware is prepared, the backup file is downloaded from the file server, and the backup file is read after starting the alternative hardware. Data backup and restoration are performed using the functions of the call control server.

Considering migration of the call control server to a virtual environment, the current method or a method using the snapshot function of the virtual environment can be considered for data backup and restoration. A snapshot function is a function of saving the state of a volume held by a virtual machine at a certain point in time as an image file. An image file can be used for reproducing the virtual machine at the time of the snapshot.

When using the current method, a backup file is acquired using the function of the application running on the virtual machine. At the time of recovery, a virtual machine using the startup image file is created, the backup file is downloaded from the file server, the software is started on the virtual machine, the virtual machine operates as a call control server, and then the backup file is read in the virtual machine.

When using the snapshot function, an image file of a virtual machine which operates as a call control server is acquired periodically. At the time of recovery, a virtual machine is created using the image file acquired by the snapshot. This image file includes all of an operating system (OS), middleware (MW), applications (APLs), and data (corresponding to those included in the backup file). It is possible to start the virtual machine in the state at the time at which the snapshot was taken by using the image file.

When using the current method, it is required to read the backup file after creating the virtual machine, but when using the snapshot function, it is only necessary to create the virtual machine using the image file taken by the snapshot. That is, the method using the snapshot function enables faster recovery than using the current method.

On the other hand, in the case of a software failure, the virtual machine which operates as a call control server first restarts (resets) the software part while expanding the initialization range step by step to minimize the impact on services, and when not restored, the data to be read is replaced with the backup file and the software is restarted (restart data replacement). When data replacement is restarted and the data is not recovered, the recovery work is handed over to the maintenance person.

When the current method is used, data is replaced by reading the backup file while the virtual machine is running without being deleted in the data replacement restart. Therefore, the state of the MW of the virtual machine remains the latest, and after replacing the data with the backup file, the process of resuming the data replacement continues.

However, when using the snapshot function, in order to replace the current data with the data equivalent to the backup file when resuming data replacement, after deleting the running virtual machine, it is required to create a virtual machine using an image file taken with a snapshot. When a virtual machine is created using an image file, the state of MW becomes the state at the time of snapshot. Therefore, from the virtual machine, there is a possibility that the information that the restart processing at the stage before the data replacement restart has already been repeatedly performed and that recovery has not been performed is lost, and the restart processing at the low-level stage is re-performed.

The present invention was made in view of the above circumstances, and an object of the present invention is to enable efficient recovery of a call control server on a virtual environment.

### Solution to Problem

An information processing system according to an embodiment of the present invention is an information processing system which includes a management device configured to manage one or more virtual machines operating on a virtualization platform, wherein the virtual machine includes a first volume in which software which is not updated in operation is installed, a second volume in which data which is updated in operation is arranged, and a recovery unit which transmits an image acquisition request of the second volume to the management device, and the management device includes a management unit which creates the virtual machine by arranging a first image file including software which is not updated in operation of the virtual machine in a first volume and arranging a second image file including data which is updated in operation of the virtual machine in a second volume, and a backup unit which backs up the second volume as the second image file in response to an image acquisition request from the virtual machine.

### Advantageous Effects of Invention

According to the present invention, it is possible to efficiently restore the call control server on the virtual environment.

### BRIEF DESCRIPTION OF DRAWINGS

FIG. 1 is a diagram illustrating an example of a configuration of a call control system according to an embodiment.

FIG. 2 is a diagram illustrating an example of a flow of automatic recovery processing

FIG. 3 is a diagram illustrating an example of a state of resumption in automatic recovery processing.

FIG. 4 is a diagram illustrating an example of how volumes are replaced and restarted.

FIG. 5 is a diagram illustrating an example of how a virtual machine is created on alternative hardware.

FIG. 6 is a diagram illustrating an example of a mode of a restoration process in a comparative example.

FIG. 7 is a diagram illustrating an example of a hardware configuration of a device included in a call control system.

### DESCRIPTION OF EMBODIMENTS

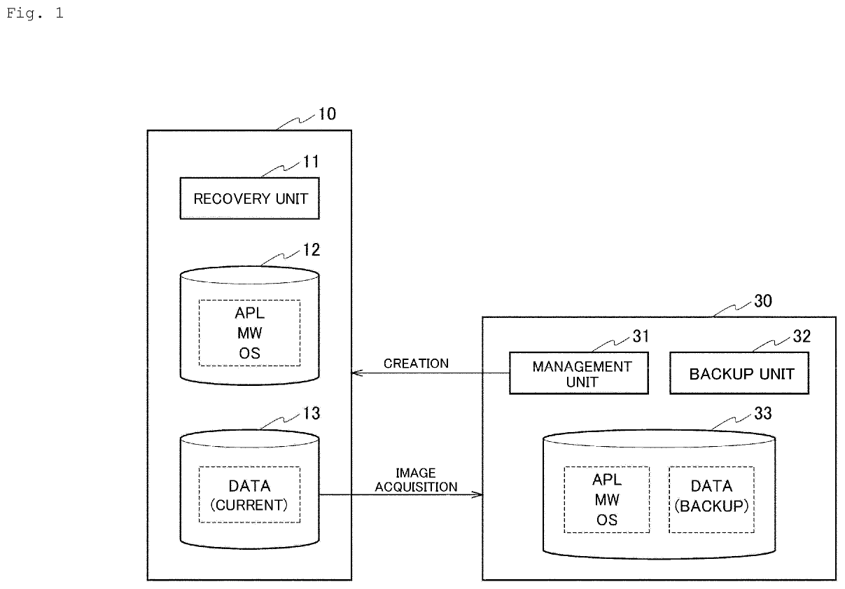

A call control system according to an embodiment will be described with reference to FIG. 1. The call control system shown in FIG. 1 is a system constructed using a virtual environment. The call control system abstracts resources provided by hardware (not shown) and operates a virtual machine 10 as a call control server on a virtualization platform. The virtual machine 10 is created using a management device 30 and deleted using the management device 30. Although only one virtual machine 10 is illustrated in FIG. 1, a plurality of virtual machines 10 may operate.

The management device 30 includes a management unit 31, a backup unit 32, and a storage unit 33.

The management unit 31 creates the virtual machine 10 and stops and deletes the virtual machine 10 in operation. When creating the virtual machine 10, the management unit 31 arranges an image file including an OS, an MW, and an APL in the volume 12 of the virtual machine 10 and arranges an image file including data in the volume 13 of the virtual machine 10. That is, the software (OS, MW, and APL) which makes the virtual machine 10 operate as a call control server and the data updated in operation are arranged in separate volumes 12 and 13 of the virtual machine 10.

The backup unit 32 acquires the image file of the volume 13 of the virtual machine 10 in which the data is arranged as a snapshot and stores it in the storage unit 33 in response to an image acquisition request from the virtual machine 10. The virtual machine 10 periodically transmits an image acquisition request to the management device 30 to back up the volume 13. The image file of the volume 13 obtained by snapshot includes data corresponding to the conventional backup file.

The backup unit 32 creates the volume 13 from the image file stored in the storage unit 33 in response to the volume creation request from the virtual machine 10.

The storage unit 33 holds an image file including an OS, an MW, and an APL and an image file of the volume 13 including data.

The virtual machine 10 includes a recovery unit 11 and volumes 12 and 13.

The volumes 12 and 13 are storage devices used by the virtual machine 10 and configured as separate storage devices using resources provided from the virtualization platform. The call control system can take a snapshot in units of volumes 12 and 13.

An image file including an OS, an MW, and an APL is installed in the volume 12 and various software is started from the volume 12. Since the OS, the MW, and the APL are updated only when the function is updated, it is basically unnecessary to periodically acquire the image file of volume 12.

Data which is updated while the virtual machine 10 is operating is arranged in the volume 13. A snapshot of the volume 13 is periodically taken using the management device 30. Image files in volume 13 are managed by management device 30.

The recovery unit 11 transmits an image acquisition request requesting a snapshot of the volume 13 to the management device 30, for example, once a day. When a software failure is detected, the recovery unit 11 restarts the software operating on the virtual machine 10 while expanding the initialization range in stages. For example, the recovery unit 11 performs the restart processing step by step in order of restarting the APL process, restarting the MW process, and restarting the OS. When the software is not recovered even after the gradual restart of the software, the recovery unit 11 performs data replacement and restart. When resuming data replacement, the recovery unit 11 transmits a volume creation request to the management device 30 and replaces the volume 13 including the current data with a newly created volume. The newly created volume contains data equivalent to a backup file. Data replacement is performed in the order of the backup file and the boot guarantee file. A boot guarantee file is a file including initial data.

The recovery unit 11 holds information about the initialization range. Since the virtual machine 10 is not deleted even when data replacement is restarted, the initialization range information held by the recovery unit 11 is not lost. A MW installed in the virtual machine 10 may function as the recovery unit 11.

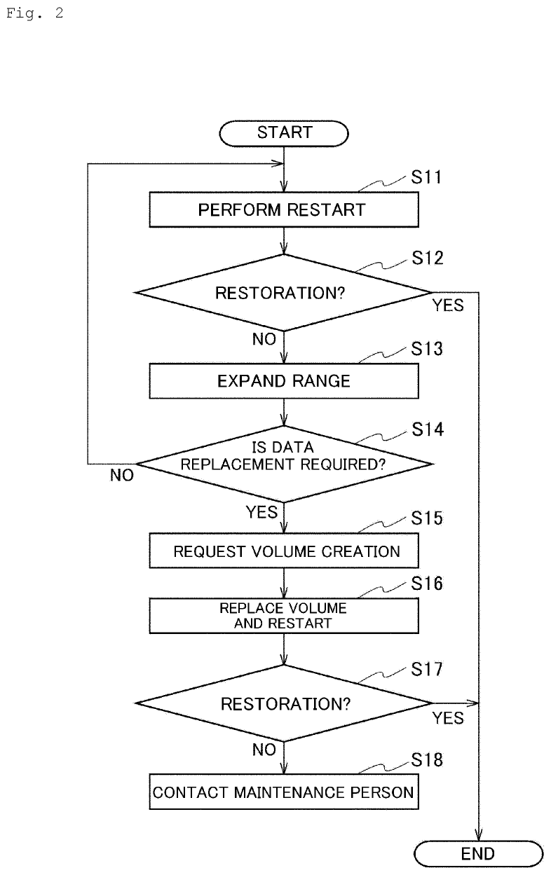

The flow of automatic recovery processing using the recovery unit 11 will be described below with reference to the flowchart of FIG. 2. The recovery unit 11 starts automatic recovery processing shown in the flowchart of FIG. 2 when detecting a software failure.

In Step S11, the recovery unit 11 performs restart within the designated initialization range. For example, the recovery unit 11 initially restarts the APL process.

In Step S12, the recovery unit 11 determines whether the software failure has been recovered. When the system recovers from the software failure, the automatic recovery process is terminated.

When recovery from the software failure has not occurred, the recovery unit 11 expands the range of restart in Step S13. For example, the recovery unit 11 widens the range of restart in the order of restarting the APL process, restarting the MW, restarting the OS, and restarting with data replacement.

In Step S14, the recovery unit 11 determines whether data replacement is required.

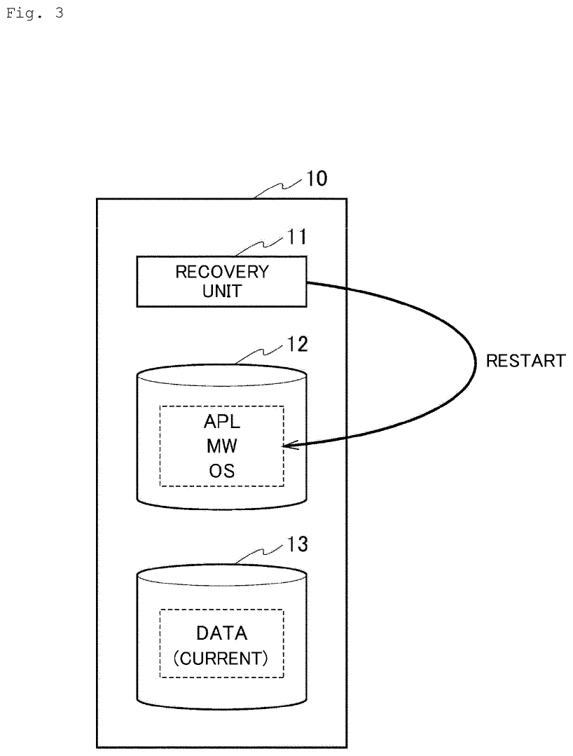

When data replacement is not required, the recovery unit 11 advances the process to Step S11 and performs restart at a specified stage. FIG. 3 shows how the software restarts when data replacement is not required. The recovery unit 11 restarts the APL, the MW, and the OS according to the stage while keeping the data of the volume 13 as the current data.

When data replacement is required, the recovery unit 11 transmits a volume creation request to the management device 30 in Step S15.

When the volume is created, in Step S16, the recovery unit 11 replaces the volume 13 with a newly created volume and performs restart.

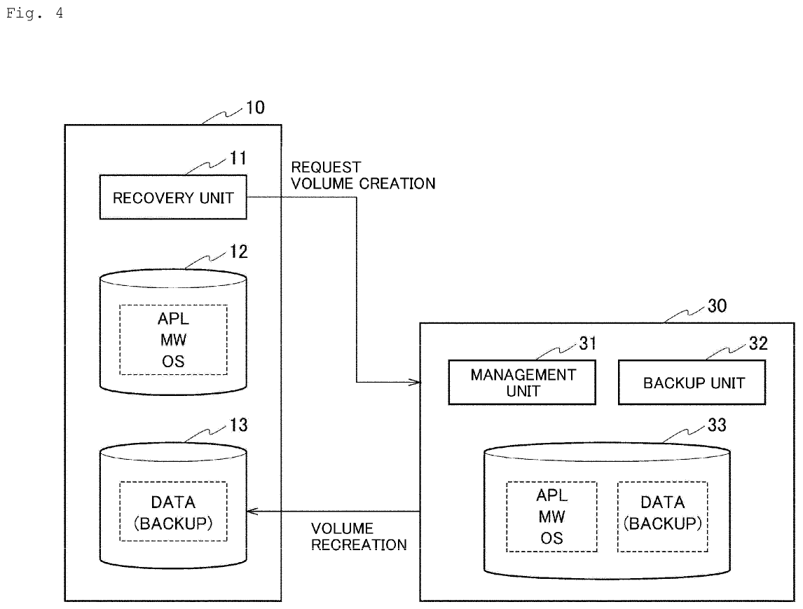

FIG. 4 shows how data replacement is restarted. When receiving a volume creation request from the virtual machine 10, the management device 30 creates a new volume 13 using an image file including data corresponding to a backup file. The recovery unit 11 replaces the volume 13 with a new volume 13 and performs restart. For example, the recovery unit 11 performs restart from restart-up of the OS after replacing the volume 13.

In Step S17, the recovery unit 11 determines whether the software failure has been recovered. When the system recovers from the software failure, the automatic recovery process is terminated.

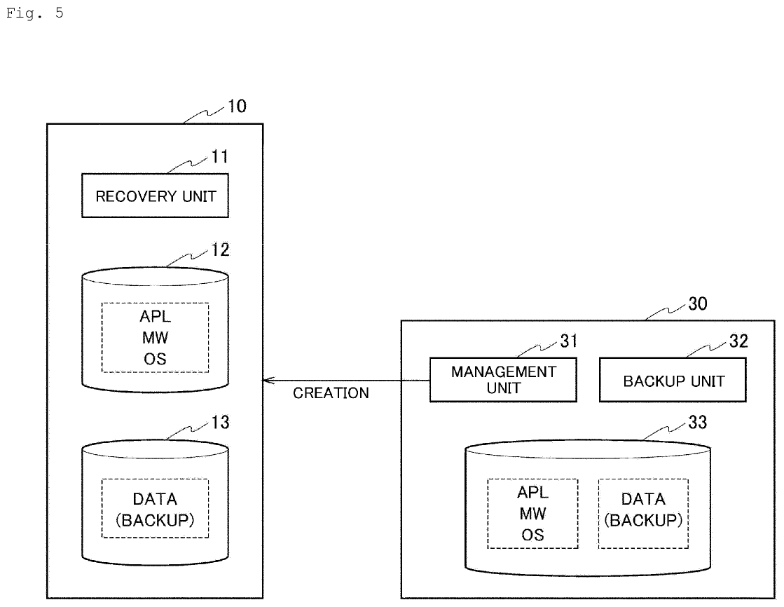

When the data replacement restart does not restore the data, in step S18, the recovery unit 11 contacts the maintenance person to hand over the restoration work to the maintenance person. The maintenance person creates, for example, a virtual machine 10 on alternative hardware. Alternative hardware is delivered by a virtualization platform. FIG. 5 shows how the virtual machine 10 is created on alternative hardware (not shown). When creating the virtual machine 10 on alternative hardware, the management device 30 creates the virtual machine 10 by combining multiple image files. Specifically, the virtual machine 10 is created by installing an image file including the OS, the MW, and the APL to the volume 12 and installing an image file containing data to the volume 13. The data in the volume 13 of the virtual machine 10 which is newly created is data corresponding to the backup file in which the snapshot was taken the day before.

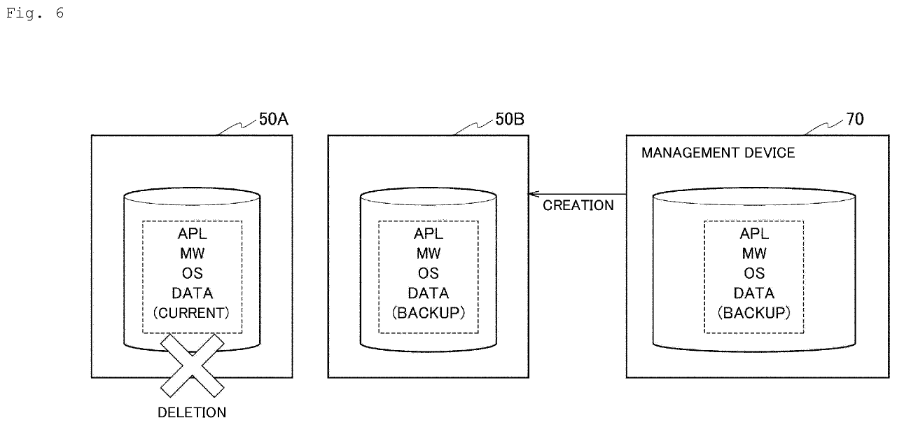

A comparative example of backing up data using snapshots without dividing data into separate volumes will be described below with reference to FIG. 6. In a comparative example, a snapshot of a volume including an OS, an MW, an APL and data is taken as a backup.

In the event of a software failure, the virtual machine 50A performs a gradual restart to attempt recovery. The restart is executed with the current data as it is until the OS is restarted. When the OS is not restored even if the OS is restarted, the data need to be replaced. When replacing the data, the management device 70 deletes the virtual machine 50A and recreates the virtual machine 50B using an image file including data corresponding to the backup file. In the recreated virtual machine 50B, not only the data but also the OS, the MW, and the APL states are in the state at the time of the snapshot. The recreated virtual machine 50B has lost information about how far the automatic recovery process has progressed. Therefore, after the virtual machine 50B is created, there is a risk that the restart process which has already been performed in the virtual machine 50B will be performed again.

As explained above, the virtual machine 10 includes the volume 12 in which an OS, an MW, and an APL which are not updated in operation are installed, the volume 13 in which data which is updated in operation is installed, and the recovery unit 11 which transmits an image acquisition request for the volume 13 to the management device 30. The management device 30 includes the management unit 31 which creates the virtual machine 10 by installing an image file including an OS, an MW, and an APL to the volume 12 and installing an image file including data updated while the virtual machine 10 is operating to the volume 13 and the backup unit 32 which backups up the volume 13 as an image file in response to an image acquisition request from the virtual machine 10. The recovery unit 11 gradually widens the initialization range and restarts the software when the software failure occurs and transmits a volume creation request to the management device 30 when the initialization range reaches a predetermined stage, and the backup unit 32 creates a new volume 13 using the image file in response to the volume creation request. The recovery unit 11 replaces the volume 13 with a new volume 13 created in response to the volume creation request. Thus, since it is possible to continue recovery by replacing only the volume 13 in which the data is located without rewinding the state of the recovery unit 11 (for example, MW) which holds the initialization range, unnecessary re-execution of already-executed restart processing can be prevented.

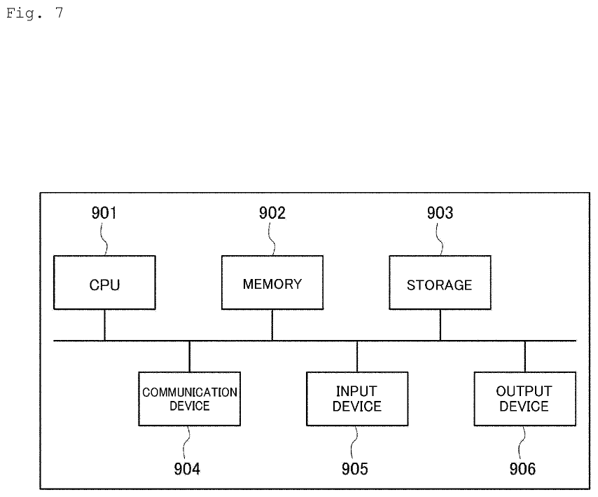

For example, a general-purpose computer system including a central processing unit (CPU) 901, a memory 902, a storage 903, a communication device 904, an input device 905, and an output device 906, as shown in FIG. 7 can be used for the device provided in the call control system described above. In this computer system, the CPU 901 executes a predetermined program loaded on the memory 902 to implement the device provided in the call control system. This program can be recorded on a computer-readable recording medium such as a magnetic disk, an optical disk, or a semiconductor memory, or distributed via a network.

Note that, although the call control system using a virtual environment has been described in this embodiment, the present invention can be applied to any information processing system in which recovery is attempted using a backup file.

### REFERENCE SIGNS LIST

10 Virtual machine
11 Recovery unit
12, 13 Volume
30 Management device
31 Management unit
32 Backup unit
33 Storage unit

1. An information processing system which includes a management device configured to manage one or more virtual machines operating on a virtualization platform, wherein
the virtual machine includes
a first volume in which software which is not updated in operation is installed,
a second volume in which data which is updated in operation is arranged, and
a recovery unit, including one or more processors, configured to transmit an image acquisition request of the second volume to the management device, and
the management device includes
a management unit, including one or more processors, configured to create the virtual machine by arranging a first image file including software which is not updated in operation of the virtual machine in a first volume and arranging a second image file including data which is updated in operation of the virtual machine in a second volume, and
a backup unit, including one or more processors, configured to back up the second volume as the second image file in response to an image acquisition request from the virtual machine.

2. The information processing system according to claim 1, wherein:
the recovery unit is configured to expand an initialization range step by step when a failure occurs and restarts the software, transmit volume creation request to the management device when the initialization range reaches a predetermined stage, and replace the second volume with a new volume created in response to the volume creation request, and
the backup unit is configured to create the new volume using the second image file in response to the volume creation request.

3. A management device which manages one or more virtual machines operating on a virtualization platform, comprising:
a management unit, including one or more processors, configured to create the virtual machine by arranging a first image file including software which is not updated in operation of the virtual machine in a first volume and arranging a second image file including data which is updated in operation of the virtual machine in a second volume, and
a backup unit, including one or more processors, configured to back up the second volume as the second image file in response to an image acquisition request from the virtual machine.

4. The management device according to claim 3, wherein
the backup unit is configured to create a new volume using the second image file in response to a volume creation request from the virtual machine.

5. A management method for managing one or more virtual machines operating on a virtualization platform, comprising:
creating the virtual machine by arranging a first image file including software which is not updated in operation of the virtual machine in a first volume and arranging a second image file including data which is updated in operation of the virtual machine in a second volume, and
backing up the second volume as the second image file in response to an image acquisition request from the virtual machine.

6. The management method according to claim 5, comprising:
creating a new volume using the second image file in response to a volume creation request from the virtual machine.

7. A non-transitory computer readable medium storing one or more instructions causing a computer to function as the management device according to claim 3.
